(19) United States
(12) Patent Application Publication
(10) Pub. No.: US 2018/0001817 A1
(43) Pub. Date: Jan. 4, 2018

(54) Message Display System for Vehicles

(71) Applicant: Sonya Adams, Evansville, IN (US)

(72) Inventor: Sonya Adams, Evansville, IN (US)

(21) Appl. No.: 15/196,690

(22) Filed: Jun. 29, 2016

(51) Int. Cl. B60Q 9/00; G09G 5/34; B60R 11/02; G06F 3/02; B60R 11/00

(52) U.S. Cl. CPC B60Q 9/00; B60R 11/0229; G06F 3/0219; G09G 5/34; B60R 2011/0026; G09G 2354/00; G09G 2370/16; G09G 2380/10; G09G 2340/0464

(57) ABSTRACT

A message display system for a vehicle. The system includes a base unit an LED display, a receiver capable of wirelessly receiving text, suction cups that enables attachment of the base unit to a rear window of a vehicle such that the display faces out the rear window. The system also includes at least one transmitter capable of wirelessly transmitting text to the receiver of the base unit, Such transmitters can include portable electronic devices such as as a dedicated remote control device, a mobile phone, a smart phone, a tablet computer. The base unit can also be configured to receive alerts from an alert system such as an Amber Alert system.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### FIELD

At least some embodiments disclosed herein relate, in general, to message display systems and more specifically to message display systems for use in vehicles.

### BACKGROUND

When a vehicle malfunctions, it creates inconvenience for the driver, especially if it stops while he or she is on the road. It can takes a long time for help from AAA or another roadside service company to arrive, wasting valuable time, and it can be dangerous. No one wants to sit in a disabled vehicle for hours when it is very hot or very cold, and the extreme temperatures inside the vehicle can be hazardous for one's health. It can be even more dangerous to get out and walk down the highway, especially at night or when the driver is in unfamiliar territory.

When someone stops to check on the vacant vehicle, there is no way to know what may have happened to the missing driver. These concerns can be intensified when parents worry about their teenaged drivers, when seniors with health problems are on the road, or when mothers are driving with young children in their vehicles. When a person is experiencing a medical crisis or a pregnant woman is about to have a baby, the person needs some way to solicit emergency assistance from other drivers passing by.

### SUMMARY

In an embodiment, the present disclosure relates to a message display system for a vehicle. The system includes a base unit an LED display, a receiver capable of wirelessly receiving text, suction cups that enables attachment of the base unit to a rear window of a vehicle such that the display faces out the rear window. The system also includes at least one transmitter capable of wirelessly transmitting text to the receiver of the base unit, Such transmitters can include portable electronic devices such as as a dedicated remote control device, a mobile phone, a smart phone, a tablet computer. The base unit can also be configured to receive alerts from an alert system such as an Amber Alert system.

Various other embodiments, alternative and variations of the message display system of the present disclosure and its components are described below.

### BRIEF DESCRIPTION OF THE DRAWINGS

The embodiments are illustrated by way of example and not limitation in the figures of the accompanying drawings in which like references indicate similar elements.

FIG. 1 illustrates an embodiment of a system comprising a base unit with a display and one or more portable electronic devices that are capable of transmitting text data to the base unit, causing the base unit to display the text.

FIG. 2 illustrates an embodiment of a base unit in accordance with the present disclosure.

FIG. 3 Illustrates an embodiment of a base unit in accordance with the present mounted on the rear window of an exemplary vehicle, such that the display of the base unit is visible from the rear of the vehicle.

FIG. 4 illustrates an embodiment of a dedicated remote control device unit in accordance with the present disclosure.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

As used herein, the term “vehicle” should be understood to refer to any type of conveyance moving on wheels, runners, tracks, or the like, such as an automobile, truck, RV, cart, sled, or trailer, and more specifically, conveyances having windows where a display device can be mounted.

In an embodiment, the present disclosure relates to systems that provide a way for occupants of a vehicle to communicate messages, for example, request for assistance, or to provide safety information or various other types of messages to other vehicles by creating highly visible scrolling messages displayed in the rear window of the vehicle.

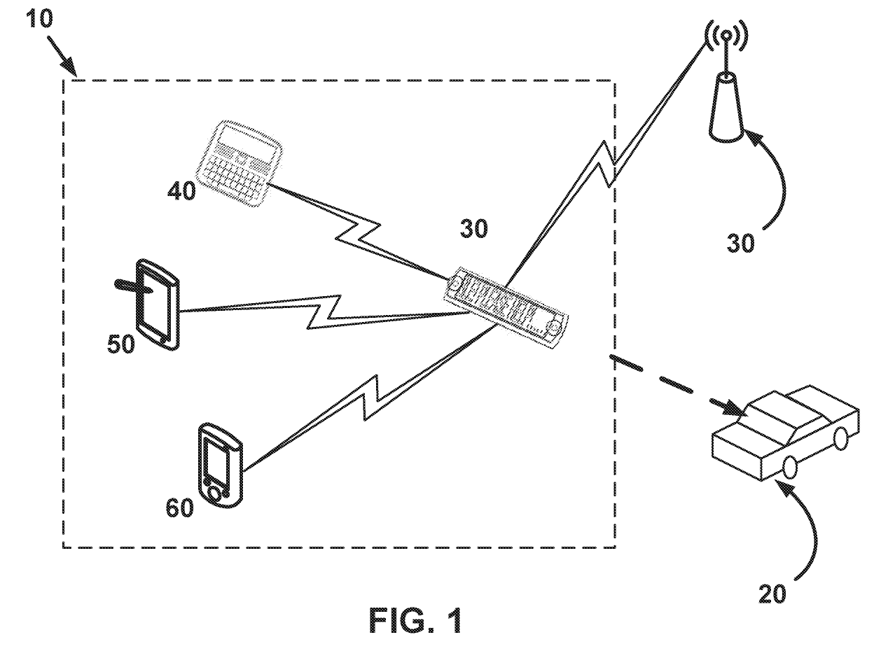

Referring first to FIG. 1, in an embodiment, the system 10 comprises a base unit 30 with a display, and one or more portable electronic devices that are capable of transmitting text data to the base unit 30, causing the base unit to display the text. In the illustrated embodiment, the portable devices can include one or more of a dedicated remote control device 40, a tablet computer 50, and a smart phone 60.

In the illustrated embodiment, all the portable electronic devices 40, 50, and 60 and the base unit 30 are located within a vehicle 20. The base unit 30 is mounted on the rare window of the vehicle 20 such that the display of the base unit 30 is visible from outside the vehicle 20. The portable electronic devices 40, 50, and 60 are in the possession of passengers or the driver of the vehicle 20. In an embodiment, the base unit is capable of receiving alerts from alert system 30 such as an Amber Alert system.

In an exemplary use of the system, if a passenger or the driver of the vehicle 20 wishes to display a message on the display of the base unit 30, the passenger or the driver enters in a text message on one of the portable electronic devices 40, 50, and 60. The portable electronic device used then transmits the text message to the base unit 30, which are then displays a message on its display such that the message is visible from outside the vehicle 20.

Such messages could be any kind of message that is useful under the circumstances, for example, “Please Send Help”. In an embodiment, the base unit is also configured to receive alerts from an alert system 30 and display the alerts on the display of the base unit 20.

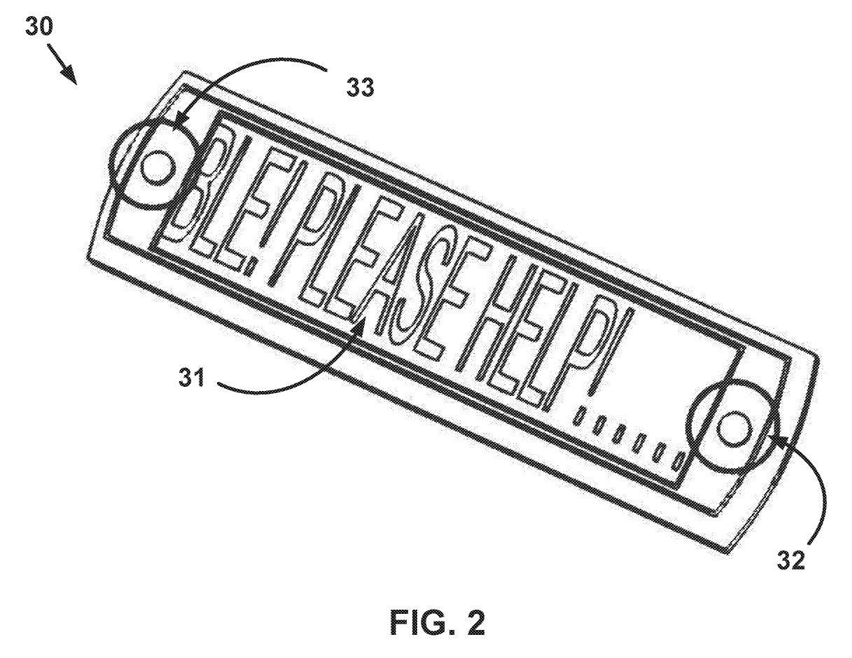

FIG. 2 Illustrates an embodiment of a base unit 30 in accordance with the present disclosure, for example the base unit 30 of FIG. 1.

In an embodiment, the base comprises a display 31 for displaying, a receiver capable of wirelessly receiving text (not visible, within the body of the base unit), and attachment devices 32 and 33, for example, suction cups, that enable attachment of the base unit to a window, for example, the rear window of a vehicle, such that the display faces out the window. The 31 display displays text wirelessly received by the receiver of the base unit 30.

In an embodiment, the display 31 is an LED display. In other embodiments, the display 31 could be any suitable display, such as, for example, a backlit LCD display, or any other suitable display now known or later to be developed in the art. In an embodiment, the display 31 is capable of scrolling a text message received by the receiver of the base unit when a length of the text message exceeds a number of characters the display is configured to display. In an embodiment, the display 31 is capable of displaying flashing text, for example, for urgent messages.

In an embodiment, the receiver of the base unit 30 is additionally configured to receive alerts from an alert system, for example an Amber Alert system, such that the alerts are displayed on the display of the base unit 30.

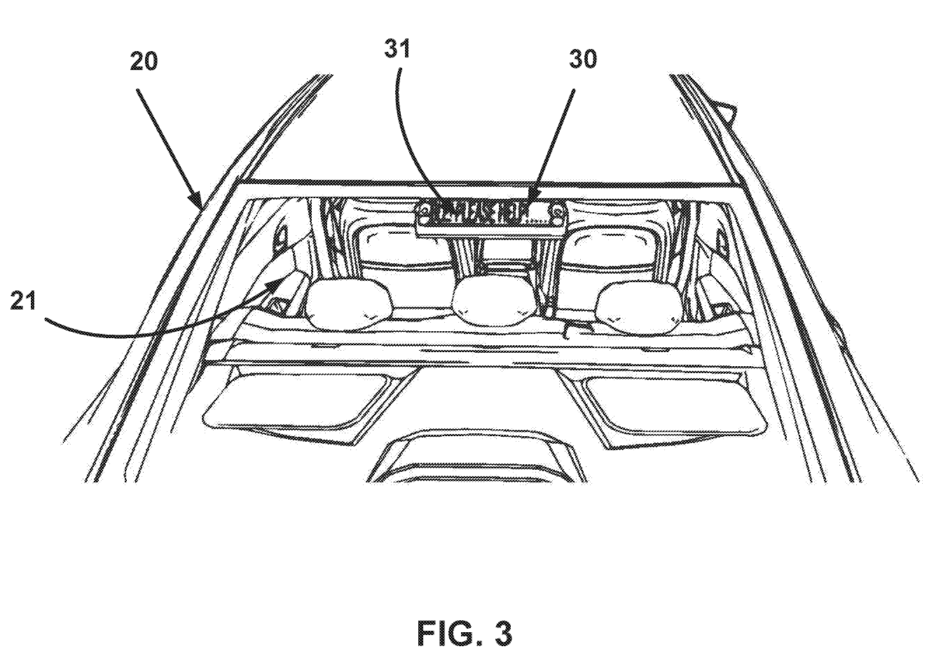

FIG. 3 Illustrates an embodiment of a base unit 30 in accordance with the present disclosure, for example the base unit 30 of FIG. 1 and FIG. 2, mounted on the rear window 21 of an exemplary vehicle 20, such that the display 31 of the base unit 30 is visible from the rear of the vehicle 20. As so positioned, any text messages displayed on the display 31 of the 20 unit are visible from the rear of the vehicle 20.

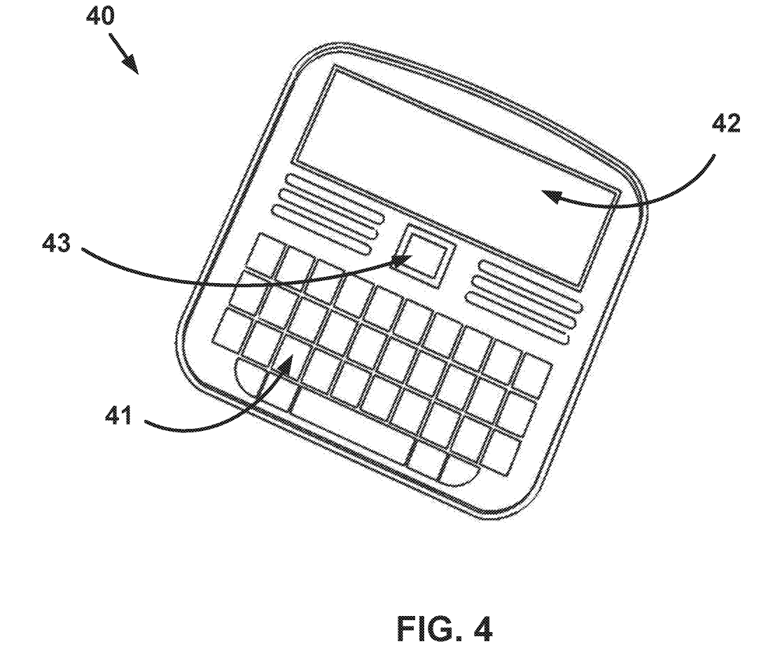

FIG. 4 illustrates an embodiment of a dedicated remote control device 40 unit 40 in accordance with the present disclosure such as, for example the dedicated remote control device 40 of FIG. 1.

It should be understood that “dedicated remote control device” is intended to refer to a device whose sole function is to control the operation of a base unit of the present disclosure, such as the base unit 30 of FIG. 1-3. The dedicated remote control device functions as a transmitter that wirelessly transmits user specified text to the receiver of a base unit (for example, the base unit 30 of FIG. 1-3).

The dedicated remote control unit 40 illustrated in FIG. 4 has an alphanumeric keypad 42 that allows a user to enter text into the unit 40 and an LCD display 42 that displays the text the user entered using the alphanumeric keypad 42. The dedicated remote control unit 40 wireless transmission components (within the housing of the remote control unit 40, not visible in the FIG. 4) that transmit text entered by the user using the alphanumeric keypad 42 to the receiver of a base unit (for example, the base unit 30 of FIG. 1-3) when the user presses a transmit button 43.

In an embodiment, the dedicated remote control unit 40 transmits text, and the receiver of a base unit receives text, using a short range wireless protocol such as, for example, the Bluetooth® wireless transmission protocol. In an embodiment, the dedicated remote control unit 40 transmits text, and a base unit receives text, using a short range wireless protocol such as, for example, the Bluetooth® wireless transmission protocol.

In an embodiment, the dedicated remote control unit 40 has at least one stored text message that the unit transmits to the receiver of the base unit in response to an entry of an abbreviated command, for example, a short-cut code or a function button, by the user into the dedicated remote control unit 40. In an embodiment, Such stored text messages could be predefined text messages (e.g. supplied by the manufacturer) and/user defined text messages (e.g. entered by the user using the alphanumeric keypad 42 and stored in response to a command entered on the keypad.)

Those skilled in the art will appreciate that other portable electronic devices, such as, for example, the tablet computer 50 or the smart phone 60 of FIG. 1, could be supplied with a software application (e.g. a mobile “app”) or specialize hardware or firmware such that such portable electronic devices perform functions similar to or identical to the dedicated remote control unit 40.

As will be readily apparent to those skilled in the art, the systems of the present disclosure can ensure the safety and well-being of all motorists. In various embodiments, the product provides a convenient way for those who find themselves in stressful situations such as, for example, when their car breaks down or someone is experiencing a medical crisis, to communicate their need for assistance to others. The system can help to eliminate or reduce the danger of sitting alone in a very hot or very cold vehicle while waiting for help.

Passing motorists will be able to provide the assistance needed to help the driver get back on the road. Parents of young drivers, elderly drivers, and mothers traveling with children will have greater peace of mind knowing they can get the assistance they need in a timely fashion should they experience a roadside emergency.

In various embodiments, if the driver of a vehicle decides to walk away from the vehicle, he or she will be able to leave a message with details about their whereabouts for law enforcement officers or family members who may stop to check on the abandoned vehicle.

The use of the system can, in various embodiments, also be used by a driver of a vehicle to communicate with other drivers in non-emergency situations by sending various types of messages to other drivers such as, for example, “Stop Tailgating Me!”, “Have a Nice Day”, “I See a Radar Trap”, and so forth. In some embodiments, the system can extend the reach of the Amber Alert system by displaying Amber Alerts and/or Silver Alerts.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

1. A system comprising:
a base unit comprising
a display capable of displaying text,
a receiver capable of wirelessly receiving text,
at least one attachment device that enables attachment of the base unit to a window such that the display faces out the window,
wherein the display displays text wirelessly received by the receiver; and
at least one transmitter capable of wirelessly transmitting text to the receiver of the base unit.

2. The system of claim 1, wherein the display is an LED display.

3. The system of claim 2, wherein the display is capable of scrolling a text message received by the receiver of the base unit when a length of the text message exceeds a number of characters the display is configured to display.

4. The system of claim 3 wherein the at least one attachment device comprises at least two suction cups.

5. The system of claim 1, wherein the at least one transmitter is a dedicated remote control device having a keypad and a display screen, such that a text message entered into the dedicated remote control device by a user is transmitted to the receiver of the base unit.

6. The system of claim 5 wherein the dedicated remote control device has at least one stored text message that the dedicated remote control device transmits at least one stored text message to the receiver of the base unit in response to an entry of an abbreviated command by the user into the remote control device.

7. The system of claim 6 wherein the at least one stored text message comprises at least one predefined text message and at least one user defined text message.

8. The system of claim 1, wherein the at least one transmitter is at least one portable electronic device selected from the list: a mobile phone, a smart phone and a tablet computer, wherein the at least one mobile device has an application program that enables a user of the at least one portable electronic device to enter a text message into the at least one portable electronic device such the text message is transmitted to the receiver of the base unit.

9. The system of claim 8 wherein the at least one mobile device has at least one stored text message that the at least one portable electronic device that the at least one portable electronic device transmits to the receiver of the base unit in response to an entry of an abbreviated command by the user into the at least one portable electronic device.

10. The system of claim 9 wherein the at least one stored text message comprises at least one predefined text message and at least one user defined text message.

11. The system of claim 1, wherein the receiver of the base unit is additionally configured to receive alerts from an alert system, such that the alerts are displayed on the display of the base unit.

12. The system of claim 1, wherein the broadcast alert system is an Amber Alert system.

13. The system of claim 1, wherein the window is a window of a vehicle.

14. The system of claim 9 wherein the window of a vehicle is the rear window of the vehicle.

15. A system comprising:
a base unit comprising
an LED display capable of displaying text,
a receiver capable of wirelessly receiving text,
at least one attachment device that enables attachment of the base unit to a rear window of a vehicle such that the display faces out the rear window, the at least one attachment device comprising at least two suction cups
wherein the display displays text wirelessly received by the receiver, the display being further capable of scrolling text received by the receiver when a length of the text exceeds a number of characters the display is configured to display; and
at least one transmitter capable of wirelessly transmitting text to the receiver of the base unit, wherein at least one transmitter is at least one portable electronic device selected from the list: a dedicated remote control device, a mobile phone, a smart phone, a tablet computer;
wherein the receiver of the base unit is additionally configured to receive alerts from an alert system, such that the the alerts are displayed on the display of the base unit.
